(19) United States
(12) Patent Application Publication
(10) Pub. No.: US 2004/0267605 A1
(43) Pub. Date: Dec. 30, 2004

(54) Method of determining a formula used to describe positive and negative driving factors of an organization and depicting the formula as artwork in order to motivate members of an organization

(76) Inventor: Guy Elliott Martin, Rivonia (ZA)

Correspondence Address: BURNS, DOANE, SWECKER & MATHIS, L.L.P., P.O. Box 1404, Alexandria, VA, 22313-1404, US

(21) Appl. No.: 10/607,303

(22) Filed: Jun. 27, 2003

(51) Int. Cl. G06F 17/60

(52) U.S. Cl. 705/11

(57) ABSTRACT

A method of determining a formula used to describe positive and negative driving factors of an organisation and depicting the formula as artwork in order to motivate the members of the organisation to perform the positive driving factors and avoid the negative driving factors. The method includes the steps of conducting at least one survey of the members of the organisation in order to identify the main criteria which affect the performance of the organisation and to rank the criteria in accordance with the effect of the criteria on the performance of the organisation. The identified main criteria together are used together with the ranking of the criteria to determine a formula. A measurement survey is conducted to measure the performance of the organisation for each of the criteria in the formula and the formula is used with the obtained numerical value for each criteria within the formula to calculate an overall performance value thereby to measure the performance of the organisation. In addition, the artwork and is displayed on a wall in a suitable location at the premises of the organisation.

### BACKGROUND OF THE INVENTION

The present invention relates to a method of determining a formula used to describe positive and negative driving factors of an organisation and depicting the formula as artwork in order to motivate the members of the organisation to perform the positive driving factors and avoid the negative driving factors. The invention extends to the use of the formula to measure the performance of the organisation.

An often quoted phrase is that “competitive advantage begins at home”. In order to be winners, businesses need to compete from the inside out. Inherent in this process is the introspective search for practices, unique to the businesses own success, that lead to superior performance measured over time. These practices can be compiled into the genetic blueprint of an organisation.

In the new global economy, there have been a number of changes relating to technology, people, culture and process. However, one core element of a business that is consistent is the business's blueprint.

In addition, the new economy values one thing above all else: knowledge, which comes in many forms. One such form is the knowledge about one's own business.

Thus the present invention seeks to provide a process of actualisation, gathering information about value drivers, risks and controls, and other factors, and then developing metrics or equations by which to measure and improve performance.

### SUMMARY OF THE INVENTION

According to the present invention there is provided a method of determining a formula used to describe positive and negative driving factors of an organisation and depicting the formula as artwork in order to motivate the members of the organisation to perform the positive driving factors and avoid the negative driving factors, the method comprising the steps of:

conducting at least one elicitation survey of at least one of the members of the organisation in order to identify criteria which positively and negatively affect the performance of the organisation;

using the identified criteria to determine a formula; and

depicting the formula as artwork to graphically illustrate the formulae to members of the organisation, thereby to motivate the members of the organisation to perform the positive driving factors and avoid the negative driving factors.

The method further extends to conducting a measurement survey to measure the performance of the organisation for each of the criteria in the formula and using the formula and the obtained numerical value for each criteria within the formula to calculate an overall performance value thereby to measure the performance of the organisation.

Preferably, the formula has criteria which positively affect the performance of the organisation being added or multiplied together to form a numerator of the formula and wherein the criteria which negatively affect the performance of the organisation are added or multiplied together to form a denominator of the formula.

An at least one distilling survey may be conducted with some of the criteria identified in the elicitation survey being discarded during the distilling survey.

The at least one distilling survey may be conducted in iterations with some of the criteria identified in the previous iteration being discarded from the next iteration.

The criteria may be ranked during the at least one ranking survey or during another survey, the ranking being in accordance with the effect of the criteria on the performance of the organisation.

Depending on the ranking of the criteria, some of the criteria may have a multiplication or to the power of factor assigned to them in the formula to increase the effect of the criteria on the formula result.

Preferably, each criteria in the formula is depicted as a graphic icon.

The artwork may be displayed at an appropriate location within the organisation.

Preferably, the step of using the formula and the obtained numerical value for each criteria within the formula to calculate an overall performance value thereby to measure the performance of the organisation is repeated periodically.

The organisation may be a business, a family or a sport team, for example.

### BRIEF DESCRIPTION OF THE DRAWINGS

FIG. 1 illustrates an example artwork used for the criteria “attract and retain the best people”: and

FIG. 2 illustrates a simplified formula showing how each criteria is represented by a graphic icon and these are placed together to illustrate the formula.

### DESCRIPTION OF EMBODIMENTS

A mathematical formula is defined by the Encarta dictionary as “a rule or principle represented in symbols, numbers or letters, often in the form of an equation”.

The present invention provides a method of determining a formula, namely an algebraic equation, used to describe positive and negative driving factors of an organisation. Once identified, the formula effectively mirrors the organisation and allows for simplicity of use.

For exemplary purposes. the organisation will hereinafter be described as a business. However, it will be appreciated that the present invention could equally apply to another kind of organisation such as sports teams, families or political bodies, for example.

The fundamental structure of the formula of the prototype of the present invention is in the form of an algebraic equation having a number of criteria forming a numerator and a number of criteria forming a denominator. In the prototype of the present invention, the numerator is referred to as the “top line” and included in the numerator are positive driving factors of the business which are the criteria which positively affect the performance of the business.

Included in the denominator or “bottom line” are the negative driving factors of the business which are the criteria which negatively affect the performance of the business.

All of the criteria listed in the top line are added or multiplied together to form the numerator and all of the criteria listed in the bottom line are added or multiplied together to form the denominator. This will become clearer below with reference to the illustrated example.

Although the prototype of the present invention was implemented in this format, it is possible for the formula to take another form, such as by simply adding the positive driving factors and subtracting the negative driving factors to arrive at a single number.

In order to determine the formula for a particular business, the first step is to identify the criteria which will be included on the top line and bottom line of the formula.

In order to identify the criteria, the business is investigated by way of an elicitation survey to identify the main criteria which affect the performance of the business. It will be appreciated that any business operates by means of a vast number of criteria, but the effect of most of the criteria on the performance of the business will be negligible in comparison with the effect of some of the other criteria on the performance of the business.

Therefore, it is intended that the formula describing the business will typically only include the main criteria which affect the performance of the business, however, this may not necessarily be the case.

Practically, in order to identify these criteria, at least one member of the organisation is interviewed. In the case of a business, the business is investigated by an elicitation survey in the form of interviews which are conducted with the management and/or employees of the business. At this initial stage, the aim of the process is to elicit the widest possible range of criteria, obviously including criteria which both positively and negatively affect the performance of the business.

It will be appreciated that for the purposes of the present invention, the elicitation survey, or any of the other surveys referred to below, could be conducted by way of interviews, focus groups or any form of voting process, for example.

A distilling survey may also be conducted, sometimes in iterations, whereby a number of the most voted for criteria are retained and the remainder of the criteria are discarded before a further round of voting. These steps would not occur if only one member of the organisation was being surveyed.

Once this range of criteria are compiled, a ranking survey is conducted again of the management and/or employees of the business who vote in order to rank the criteria in accordance with the effect of the criteria on the performance of the business.

The ranking survey may be conducted in any manner, but preferably the second survey is conducted online over the Internet or using an Intranet or e-mail of the business.

After one or more iterations, a set of criteria are identified with their respective rankings and these identified criteria together with the ranking of the criteria is used to determine a formula.

It will be appreciated that the number of surveys conducted could vary from business to business. Also, some business may choose to conduct a single survey to simultaneously identify the main criteria and rank them. Other business may choose to identify the criteria and weight them all equally, i.e. not rank them.

In any event, depending on the ranking of the criteria, some of the criteria may have a multiplication or a to the power of factor assigned to them in the formula to increase the effect of the criteria on the formula results.

Once the formula in algebraic form is determined, the formula is converted into artwork, typically where each of the criteria are depicted as a graphic icon. Thus the formula becomes a combination of graphic icons which together depict the formula for the business.

The combination of graphic icons can be placed in relation to one another at an appropriate location within the business to illustrate the fundamental concepts driving the business to all who pass by the location. In particular, management and employees are constantly reminded of the criteria they are supposed to be building on and the criteria they are supposed to be avoiding.

The abovementioned method will now be described with reference to an illustrative example.

In a prototype implementation a survey of a company's business was taken using the entire organisation as the sample survey. In this particular case, one-on-one interviews were conducted with senior participants and focus group interviews were facilitated for the balance of the participants in the sample.

A wide possible range of criteria were derived which indicated both the positive criteria and the negative criteria influencing the performance of the business.

Several thousand opinions were captured and consolidated into common principle categories. For example, the following individual inputs were grouped under a common theme “attract and retain the best people”.

Attract & Retain the Best People

Apart from the deadwood that still exists excellent people that live for the company

Attract the best

Employ better people than yourself to work for you

High Focus on Staff

Keeping skilled employees

Management Attitude towards staff should change

More consulting/ business talent

More Skilled Engineers Per Customer

Must look after their staff in order to decrease the value of staff lost to competitors

People selection skills, employment, are improving

Retention of talent—look after people, stimulate them, reward them accordingly

Retention strategy for talented people required

Skilled employees in focus areas

Top talent employed by company

Try to keep staff turnover to a minimum

All the common themes of inputs are grouped into a single criteria and these are put to the vote, in this case to the employees, who vote on the twenty most crucial criteria in the organisation.

In this example, the criteria “attract and retain the best people” was ranked fourth, as can be seen in the following list:

Customer focus

“Can do” attitude

Teamwork

Attract and retain the best people

Quality people

Ability to work under pressure

Good systems, procedures & methodologies

Customer relations

Deliver on commitments

Partners

Career opportunities

Integrity and ethics

High competence/skills levels

Positive Attitude

Professional

Gaining and keeping the right customers

Advertise

Continuous improvement

Committed

After the first vote is completed, the business reviews the results and eliminates those criteria that did not appear to be a crucial to the success of the business. For example, if 132 criteria were initially identified, the business reduces the number to 56 which are carried through to a second survey and the employees are asked to again vote on the remaining 56.

A second and third iteration were conducted and the most critical criteria to success were identified.

In this example all voting for the various criteria was conducted via the survey conductor's website.

Once the list of criteria has been identified, the participants in the sample provided a ranking evaluation of the criteria in accordance with their effect on the performance of the business. The ranking survey can be a survey of at least one of the management or one of the employees of the business.

The following is an example of the ranking provided:

Top Line

Attract and Retain the Best People

Moving with the Times

Annuity Revenues

Performance and Results Driven

Integrity & Ethics

Financially Disciplined

Imagine it Done

The Right Fit

Customer Obsession

Winning systems, Procedures & Methodologies

Proactive Creativity

Understanding the Bigger Picture

Global Best Practice

Raise the Bar

Bottom Line

Too Few New Customers

Lack of Direction Poor Communication

Missed Opportunities

Downers

Mfokazi

Being the Best Kept Secret

Silo Syndrome “its not my job”

Inwardly focused

Tolerance of Dead Wood

No Follow Through

Analysis Paralysis

Passage Mafia

It will be noticed that the criteria “Attract and retain the best people” was ranked by the sample group as being the most important criteria. However, the client may use their business judgement and/or the judgements of their clients to adjust these rankings.

The identified main criteria listed above are then used together with the ranking to determine the following formula:

Attract & Retain the Best People³+(Customer Obsession+Performance and Results Driven)²+Annuity Revenues²+Integrity & Ethics×2+Financially Disciplined+Imagine it. Done.+Move with the Times+Understanding the Bigger Picture+The Right Fit+Proactive Creativity+Global Best Practice+Raise the Bar+Winning Systems, Procedures & Methodologies

Mfokazi³+(Missed Opportunities+Too Few New Customers)²+Silo Syndrome²+Lack of Direction×2+No Follow Through+Poor Communication+Inwardly Focused+Being the Best Kept Secret+Tolerance of Dead Wood+“Its not my job”+Downers+Analysis Paralysis +Passage Mafia

It will be noted that the criteria which positively affect the performance of the business are being added together to form the numerator of the formula and the criteria which negatively affect the performance of the business are added together to form the denominator of the formula.

The criteria above or below the line could equally be multiplied together, for example.

It will also be noted that some of the criteria have a multiplication factor or to the power of factor assigned to them. For example the criteria to attract and retain the best people is to the power of three which would therefore increase the affect of the criteria on the formula results.

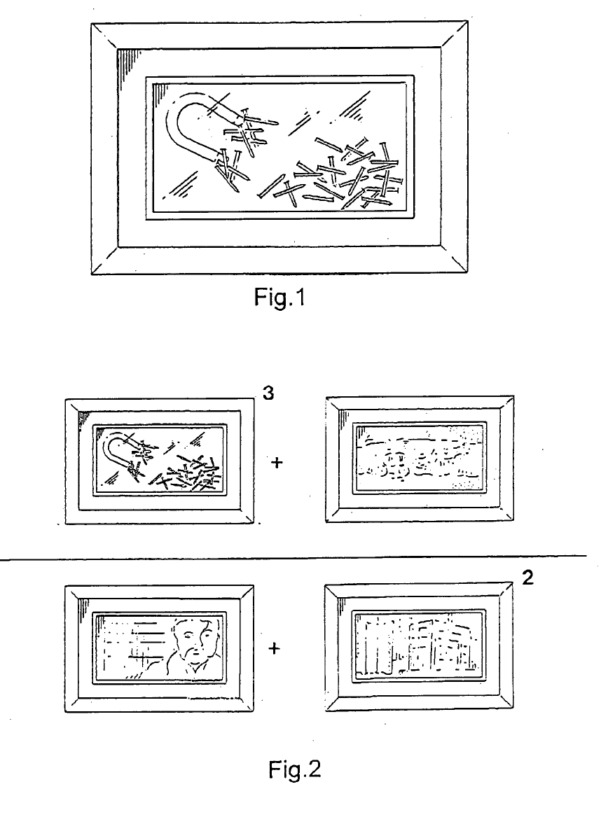

Once the formula is compiled in algebraic terms. the formula is depicted in artwork. For example, FIG. 1 illustrates a graphic icon depicting attracting and retaining the best people.

In the prototype, each graphic icon was formed from a printed, painted or three-dimensional artwork which was framed and placed together in the formula on a wall in a suitable location at the premises of the business. FIG. 2 illustrates a simplified formula in graphic format.

It will be understood that the depiction of the formula in artwork provides a motivational methodology or methodology of moulding a corporate identity in that members of the organisation are continually made aware of what they should and should not be doing. The members are focused on performing the positive driving factors and avoiding the negative driving factors. With a collective effort from the members of the organisation it has been found that the collective identity of the organisation is greatly improved and the performance of the organisation enhanced.

This enhancement comes through a “right brain language” effect. Generally accepted opinion on hemispheric functions of the brain are that the left side of the brain is the seat of language and processes in a logical and sequential order while the right side is more visual and processes intuitively, holistically and randomly. The right hemisphere does nevertheless perceive the state of things in accordance with the templates of formula, in an emotional form, to motivate certain types of behaviour and outcomes. Thus, right brain language is a communications type analogy.

It has been found that the artwork of the present invention is a useful and tangible communication model in that the physical nature of an artwork display of formula engages the emotional quotient of the minds of the members of the organisation through an effective “right brain language” method.

Once the formula has been identified, a measurement survey is taken to measure the performance of the business at periodic intervals. Typically, a sample group is queried to ascertain the value on a given scale for each criteria. For example, the survey may assess the company's performance in the area of “attract and retain the best people” on a scale of one to three. Thus. numerical values obtained for each criteria within the formula is then plugged into the formula to calculate an overall performance value thereby to measure the performance of the business.

Typically, but not exclusively, this measurement survey is also conducted electronically such as via the Internet or e-mail.

It will be appreciated that once the values for each criteria have been plugged into the formula, a numerical value will be obtained wherein the greater the numerical value, the better the performance of the business.

In the prototype of the present invention, the responses from the various members of the sample group were captured on a database so that they could be quantitatively analysed from various perspectives such as depending on the gender, race or location of the sampled members.

Apart from the quantitative results, the survey conductors may also choose to obtain qualitative feedback from the sample groups in the form of comments.

The high levels of integrity of the process, concluding with consensus, results in instilling confidence and buy in from all concerned. The capturing and graphic display of the principles in art form brings to life the real meaning of the formula to engage the mind of the business in such a manner to be unavoidable.

It will be appreciated that the resulting formula is essentially a simple formula which provides a very real method of determining the performance of the business at any given time.

I claim:

1. A method of determining a formula used to describe positive and negative driving factors of an organisation and depicting the formula as artwork in order to motivate members of the organisation to perform the positive driving factors and avoid the negative driving factors, the method comprising the steps of:
conducting at least one elicitation survey of at least one of the members of the organisation in order to identify criteria which positively and negatively affect the performance of the organisation;
using the identified criteria to determine a formula; and
depicting the formula as artwork to graphically illustrate the formulae to members of the organisation, thereby to motivate the members of the organisation to perform the positive driving factors and avoid the negative driving factors.

2. A method according to claim 1 further comprising the steps of conducting a measurement survey to measure the performance of the organisation for each of the criteria in the formula and using the formula and the obtained numerical value for each criteria within the formula to calculate an overall performance value thereby to measure the performance of the organisation.

3. A method according to claim 1 wherein the formula has criteria which positively affect the performance of the organisation being added or multiplied together to form a numerator of the formula and wherein the criteria which negatively affect the performance of the organisation are added or multiplied together to form a denominator of the formula.

4. A method according to claim 1 wherein at least one distilling survey is conducted with some of the criteria identified in the elicitation survey being discarded during the distilling survey.

5. A method according to claim 4 wherein the at least one distilling survey is conducted in iterations with some of the criteria identified in the previous iteration being discarded from the next iteration.

6. A method according to claim 1 wherein the criteria are ranked during at least one ranking survey, the ranking being in accordance with the effect of the criteria on the performance of the organisation.

7. A method according to claim 6 wherein depending on the ranking of the criteria, some of the criteria have a multiplication or to the power of factor assigned to them in the formula to increase the effect of the criteria on the formula result.

8. A method according to claim 1 wherein each criteria in the formula is depicted as a graphic icon.

9. A method according to claim 8 wherein the artwork is displayed at an appropriate location within the organisation.

10. A method according to claim 1 wherein the step of using the formula and the obtained numerical value for each criteria within the formula to calculate an overall performance value thereby to measure the performance of the organisation is repeated periodically.
